(19) United States
(12) Patent Application Publication
(10) Pub. No.: US 2026/0370382 A1
(43) Pub. Date: Nov. 19, 2026

(54) CHANNEL CODING ACROSS CODE BLOCKS (CBS)

(71) Applicant: QUALCOMM Incorporated, San Diego, CA (US)

(72) Inventors: Wei YANG, San Diego, CA (US); Jing SUN, San Diego, CA (US); Mahmoud TAHERZADEH BOROUJENI, San Diego, CA (US); Ori SHENTAL, Marlboro, NJ (US); Jing JIANG, San Diego, CA (US)

(21) Appl. No.: 19/666,106

(22) Filed: May 1, 2026

Related U.S. Application Data
(60) Provisional application No. 63/805,066, filed on May 13, 2025.

(51) Int. Cl. H04L 1/00

(52) U.S. Cl. CPC H04L 1/0057; H04L 1/0072

(57) ABSTRACT

A method for wireless communication at a user equipment (UE) and related apparatus are provided. In the method, the UE generates, based on a first set of systematic code blocks (CBs) associated with a transport block (TB), a second set of parity CBs for the first set of systematic CBs. The UE encodes the first set of systematic CBs and the second set of parity CBs using a low-density parity-check (LDPC) code, and communicates with a network entity the first set of systematic CBs and the second set of parity CBs using a first redundancy version (RV) and a second RV, respectively. The first RV indicates a first starting point of the transmission of the first set of systematic CBS, and the second RV indicates a second starting point of the transmission of the second set of parity CBs.

### CROSS REFERENCE TO RELATED APPLICATION(S)

This application claims the benefit of and priority to U.S. Provisional Application Ser. No. 63/805,066, entitled “CHANNEL CODING ACROSS CBS” and filed on May 13, 2025, which is expressly incorporated by reference herein in its entirety.

### TECHNICAL FIELD

The present disclosure relates generally to communication systems and, more particularly, to channel coding in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 6G, which is an enhancement of 5G New Radio (NR) and is a part of a continuous mobile broadband evolution promulgated by Third Generation Partnership Project (3GPP) to meet new requirements associated with latency, reliability, security, scalability (e.g., with Internet of Things (IoT)), capacity, location services, energy efficiency, artificial intelligence (AI) integration, and other requirements. Some aspects of 6G may be based on 5G NR and 4G Long Term Evolution (LTE). There exists a need for further improvements in 6G/5G technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to generate, based on a first set of systematic code blocks (CBs) associated with a transport block (TB), a second set of parity CBs for the first set of systematic CBs; encode the first set of systematic CBs and the second set of parity CBs using a low-density parity-check (LDPC) code; and communicate with a network entity the first set of systematic CBs and the second set of parity CBs using a first redundancy version (RV) and a second RV, respectively, where the first RV indicates a first starting point of the transmission of the first set of systematic CBs and the second RV indicates a second starting point of the transmission of the second set of parity CBs.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to receive, from a user equipment (UE), a signal corresponding to a first set of systematic CBs associated with a first RV and a second set of parity CBs associated with a second RV, where the first RV indicates a first starting point of the transmission of the first set of systematic CBs and the second RV indicates a second starting point of the transmission of the second set of parity CBs, and where the first set of systematic CBs is associated with a TB and the second set of parity CBs is based on the first set of systematic CBs; and process the signal based on the first RV and the second RV.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example code block (CB) structure associated with a transport block (TB).

FIG. 5 is a diagram illustrating an example encoding method for systematic CBs and parity CBs in accordance with various aspects of the present disclosure.

FIG. 6 is a diagram illustrating an example of globally coupled low-density parity-check (LDPC) codes among the CBs in accordance with various aspects of the present disclosure.

FIG. 7 is a diagram illustrating an example of applying an outer code in code block groups (CBGs) in accordance with various aspects of the present disclosure.

FIG. 8 is a diagram illustrating an example of the starting points for the transmission of systematic CBs and parity CBs in circular buffers in accordance with various aspects of the present disclosure.

FIG. 9 is a call flow diagram illustrating a method of wireless communication in accordance with various aspects of the present disclosure.

FIG. 10 is a flowchart illustrating methods of wireless communication at a UE in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a network entity in accordance with various aspects of the present disclosure.

FIG. 13 is a flowchart illustrating methods of wireless communication at a network entity in accordance with various aspects of the present disclosure.

FIG. 14 is a diagram illustrating an example of a hardware implementation for an example apparatus and/or UE.

FIG. 15 is a diagram illustrating an example of a hardware implementation for an example network entity.

### DETAILED DESCRIPTION

In wireless communication, a transport block may be segmented into smaller code blocks (CBs) for channel coding purposes. The CBs associated with a transport block (TB) may include systematic code blocks, which carry data bits, and parity code blocks, which carry parity bits for error correction. Each code block, including parity CBs and systematic CBs, may be independently encoded. At the receiver (Rx) side, the same forward error correction (FEC) decoder may be used to decode each CB individually, and no additional hardware is needed to support the FEC decoder at the CB level. However, in this design, soft-combining across multiple CBs is not supported, even though different CBs may contain related information. The lack of interconnection between CBs limits the efficiency and robustness of the decoding process. Example aspects presented herein provide methods and apparatus that enable soft-combining across different CBs using existing FEC decoder hardware, thereby achieving incremental redundancy (IR) combining gain without added decoder complexity.

Various aspects relate generally to wireless communication. Some aspects more specifically relate to channel coding in wireless communication. In some examples, a UE generates, based on a first set of systematic CBs associated with a TB, a second set of parity CBs for the first set of systematic CBs. The UE further encodes the first set of systematic CBs and the second set of parity CBs using a low-density parity-check (LDPC) code, and communicates with a network entity the first set of systematic CBs and the second set of parity CBs using a first redundancy version (RV) and a second RV, respectively. The first RV may indicate a first starting point of the transmission of the first set of systematic CBs, and the second RV may indicate a second starting point of the transmission of the second set of parity CBs. In some examples, the UE may perform a first rate matching for the first set of systematic CBs using the first RV to obtain a first set of coded bits; and perform a second rate matching for the second set of parity CBs using the second RV to obtain a second set of coded bits, and the first RV may be different from the second RV. The UE may communicate with the network entity the first set of coded bits and the second set of coded bits. In some examples, the length of coded bits for a systematic CB may be different from the length of coded bits for a parity CB. For example, the length of the coded bits for a systematic CB may be longer than the length of the coded bits for a parity CB. In some examples, the UE and the network entity may communicate the length of the coded bits for a systematic CB and the length of the coded bits for a parity CB. In some examples, the UE and the network entity may communicate the first RV and the second RV. On the receiver side, where there is a decode failure on one systematic CB of the first set of systematic CBs, the receiver may decode the one systematic CB based on the second set of parity CBs and the remaining systematic CBs in the first set of systematic CBs. For example, the receiver may first obtain a first log-likelihood ratio (LLR) of the one systematic CB corresponding to the first RV and a second LLR of the one systematic CB corresponding to the second RV. Then, the receiver may decode the one systematic CB based on the first LLR and the second LLR.

Particular aspects of the subject matter described in this disclosure can be implemented to realize one or more of the following potential advantages. In some examples, by encoding parity CBs using the same low-density parity-check (LDPC) code and assigning different redundancy versions (RVs), the described techniques enable soft-combining across systematic and parity CBs, thereby allowing the receiver to leverage multiple RVs for incremental redundancy gain and improving decoding success rates even when some CBs are lost or corrupted. In some examples, by allowing variable-length parity CBs (e.g., shorter than systematic CBs), the described techniques provide flexibility in resource allocation and overhead control, thereby improving the efficiency of the overall transmission based on network conditions and transmission priorities.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, 6G systems, or other communication systems, may be arranged in multiple manners with various components or constituent parts. As an example, in a wireless communication network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, 6G NB, 6G RAN, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

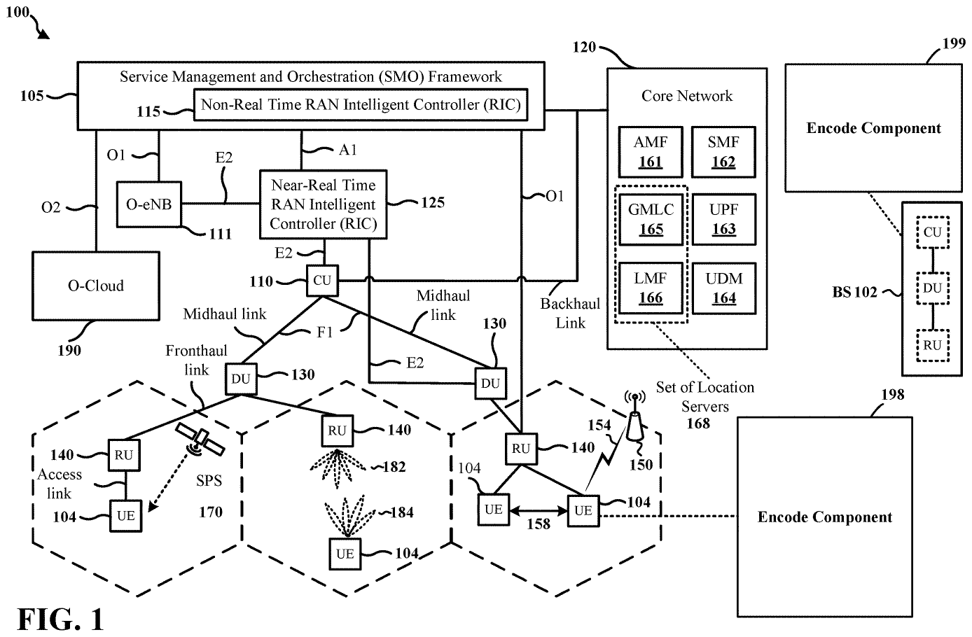

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. As an example, two initial operating bands have been identified as frequency range designations FR1 (410 MHz-7.125 GHz) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. An operating band for these mid-band frequencies may have the frequency range designation FR3 (7.125 GHZ-24.25 GHz), for example. Frequency bands falling within FR3 may inherit FR1 characteristics and/or FR2 characteristics, and thus may effectively extend features of FR1 and/or FR2 into mid-band frequencies. In addition, higher frequency bands are currently being explored to extend wireless communication operation beyond 52.6 GHz. For example, three higher operating bands have been identified as frequency range designations FR2-2 (52.6 GHz-71 GHz), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the encode component 198. The encode component 198 may be configured to generate, based on a first set of systematic CBs associated with a TB, a second set of parity CBs for the first set of systematic CBs; encode the first set of systematic CBs and the second set of parity CBs using an LDPC code; and communicate with a network entity the first set of systematic CBs and the second set of parity CBs using a first RV and a second RV, respectively, where the first RV indicates a first starting point of the transmission of the first set of systematic CBs and the second RV indicates a second starting point of the transmission of the second set of parity CBs. In certain aspects, the base station 102 may include the encode component 199. The encode component 199 may be configured to receive, from a UE, a signal corresponding to a first set of systematic CBs associated with a first RV and a second set of parity CBs associated with a second RV, where the first RV indicates a first starting point of the transmission of the first set of systematic CBs and the second RV indicates a second starting point of the transmission of the second set of parity CBs, and where the first set of systematic CBs is associated with a TB and the second set of parity CBs is based on the first set of systematic CBs; and process the signal based on the first RV and the second RV. Although the following description may give examples based on 5G NR to illustrate concepts relating to wireless communication, the concepts described herein may be applicable to other similar areas, such as LTE, LTE-A, CDMA, GSM, 6G and other wireless technologies.

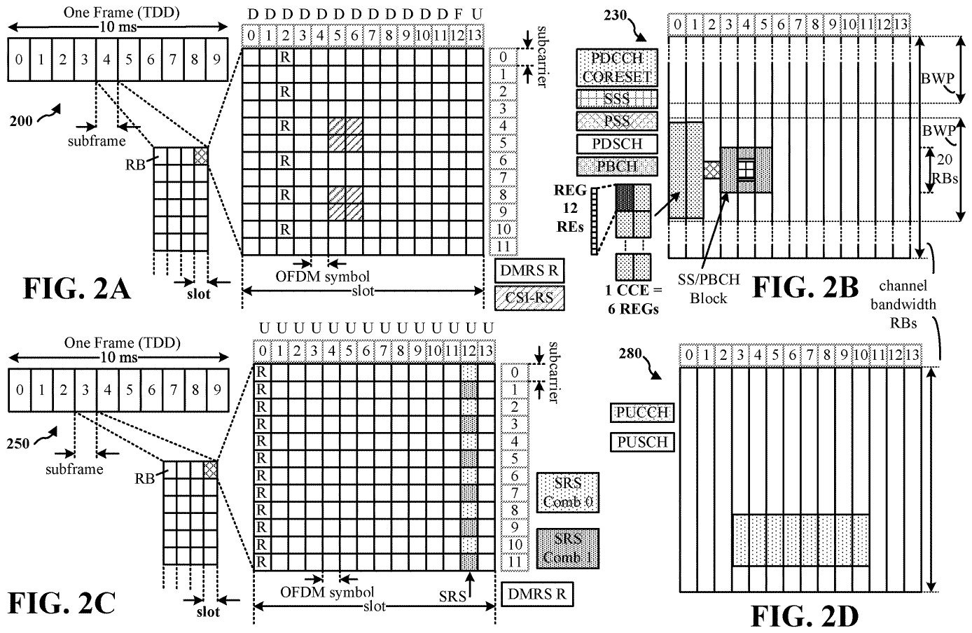

FIG. 2A is a diagram 200 illustrating an example of a first subframe within a frame structure. FIG. 2B is a diagram 230 illustrating an example of DL channels within a subframe. FIG. 2C is a diagram 250 illustrating an example of a second subframe within a frame structure. FIG. 2D is a diagram 280 illustrating an example of UL channels within a subframe. The examples in FIGS. 2A-2D show example aspects of a frame structure based on 5G NR to illustrate the concept of a frame structure and wireless communication based on a frame structure. Various aspects described in connection with FIGS. 2A-2D may also be used in connection with other wireless communication technologies, such as 6G among other examples. The frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology μ allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

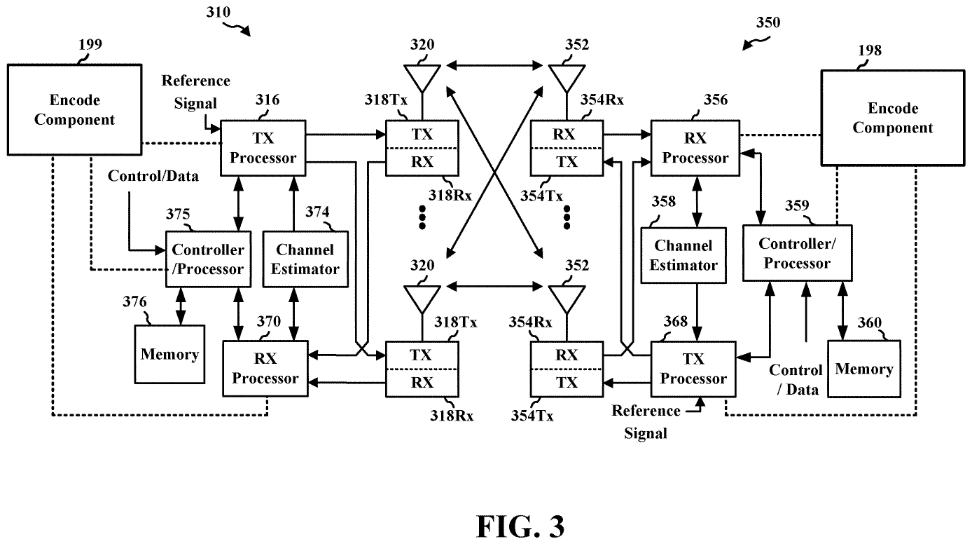

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the encode component 198 of FIG. 1.

At least one of the TX processor 316, the RX processor 370, and the controller/processor 375 may be configured to perform aspects in connection with the encode component 199 of FIG. 1.

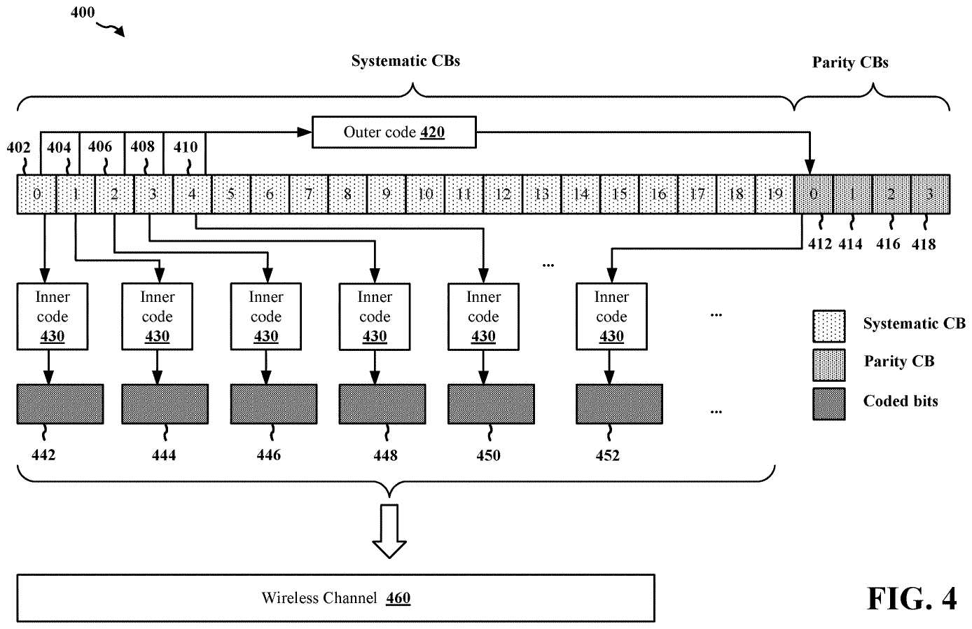

In wireless communication, information may be transmitted between a UE and a network entity via a transport block that includes a data packet. For channel coding purposes, the TB may be segmented into smaller code blocks (CBs) prior to transmission. FIG. 4 is a diagram 400 illustrating an example CB structure associated with a TB. As shown in FIG. 4, the CBs associated with a TB may include systematic CBs (e.g., systematic CBs 402, 404, 406, 408, 410), which carry data bits, and parity CBs (e.g., parity CBs 412, 414, 416, 418), which carry parity bits for error correction. A large TB may include a large number of CBs (e.g., K CBs) within the TB. If any of the CBs fails (e.g., is not successfully decoded at the receiver side), the transmission of the entire TB is considered to have failed. While code block group (CBG) based feedback may improve the retransmission granularity, it comes at the cost of increased HARQ-ACK feedback.

In some examples, a CB level channel coding, which may be referred to as an “outer code,” may be used to generate parity CBs (e.g., L parity CBs) that will be included in the transmission. The systematic CBs and the parity CBs may be further encoded using a channel coding, which may be referred to as an “inner code,” to obtain the coded bits. In some examples, the “outer code” and the “inner code” may include different encoding methods. For example, in FIG. 4, the systematic CBs 402, 404, 406, 408, 410) may go through the outer code 420 to generate the parity CB 412. Each of the systematic CBs (e.g., systematic CBs 402, 404, 406, 408, 410) may go through the inner code 430 to generate the coded bits (e.g., at 442, 444, 446, 448, 450). Each of the parity CBs (e.g., parity CB 412) may also go through the inner code 430 to generate the coded bits (e.g., at 452). For example, the inner code 430 may be an LDPC code, and the outer code 420 may be a different code. The coded bits then may be transmitted via the wireless channel 460.

In this case, if a maximum distance separable (MDS) code, such as a Reed-Solomon (RS) code, is used as the outer code (e.g., outer code 420), the receiver side may recover all CBs as long as it correctly receives K CBs. In other words, this allows up to L CBs in the TB to fail while still enabling recovery of the full TB at the receiver side.

In the example of FIG. 4, each CB, including parity CBs (e.g., parity CB 412) and systematic CBs (e.g., systematic CBs 402, 404, 406, 408, 410), is separately encoded (e.g., via inner code 430). The receiver side may use the same forward error correction (FEC) decoder hardware, which may not include the outer code (e.g., outer code 420), to decode each CB. Hence, no additional hardware is needed to support the FEC decoder at the CB level. However, in the example of FIG. 4, the outer code (e.g., outer code 420) servers as an erasure code (e.g., code designed to recover lost or “erased” data packets or bits), and no soft-combining (e.g., the combination of multiple retransmissions of the same data to improve the likelihood of correct decoding at the receiver) is used across multiple CBs (e.g., systematic CBs 402, 404, 406), even though they may contain related information. Example aspects presented herein provide methods and apparatus that enable soft-combining across different CBs using existing FEC decoder hardware, thereby achieving IR combining gain without added decoder complexity.

In some aspects, the parity code blocks may be encoded using the same LDPC code as the systematic CBs. However, when performing rate matching to obtain the coded bits, a different RV may be used for the parity CBs than the RVs used for the systematic CBs.

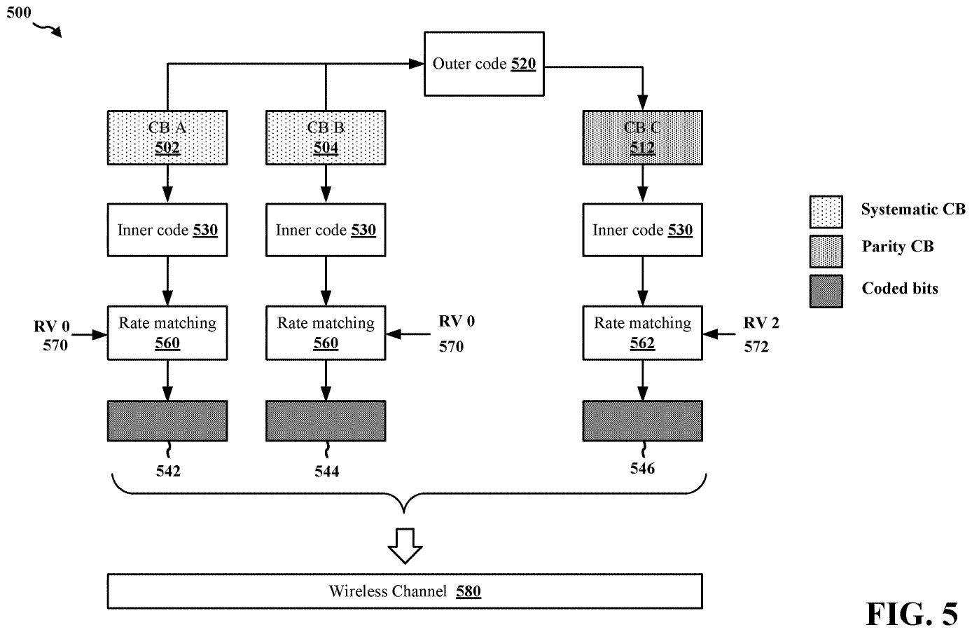

FIG. 5 is a diagram 500 illustrating an example encoding method for systematic CBs and parity CBs in accordance with various aspects of the present disclosure. The example in FIG. 5 involves two systematic CBs (e.g., CB A 502, CB B 504) and one parity CB (e.g., CB C 512). As an example, the parity CB (e.g., CB C 512) may be generated based on systematic CBs (e.g., CB A 502, CB B 504) via outer code 520. As an example, the parity CB (e.g., CB C 512) may be generated based on: CB C=CB A @ CB B, where @ denotes the bit-wise exclusive OR (XOR) operation. Then, all these CBs, including systematic CB A 502 and CB B 504, and parity CB C 512, may be separately encoded using the inner code 530 to obtain coded bits (e.g., coded bits 542, 544, 546). For example, the inner code 530 may be the LDPC code. When performing rate matching, different RVs may be used for systematic CBs (e.g., CB A 502 and CB B 504) and parity CB (e.g., CB C 512). For example, the first RV (e.g., RV 0 570) may be used for CB A 502 and CB B 504 at rate matching 560, and the second RV (e.g., RV 2 572), which may be different from the first RV (e.g., RV 0 570), may be used for the parity CB (e.g., CB C 512) at rate matching 562. The coded bits (e.g., coded bits 542, 544, 546) then may be transmitted via the wireless channel 580.

At the receiver side, if one CB fails and the other CB succeeds, for example, coded bits 542 corresponding to CB A 502 fails to be decoded and coded bits 544 corresponding to CB B 504 can be successfully decoded, then the receiver may re-encode the CB that has been successfully decoded (e.g., CB B 504) and compute the expression:

LLR(CB C, RV2)*(−1)^{ENC(CB} B, RV2)=LLR(CB A, RV2) (1)

where LLR(·) represents the log-likelihood ratio operation and ENC(CB, RV) represents the encode of CB using RV (e.g., RV 2 572).

According to Equation (1), the receiver will have the LLRs corresponding to both RV 0 570 and RV 2 572 of CB A 502. This enables the receiver to perform soft-combining across the RVs (e.g., RV 0 570, RV 2 572) to obtain the IR combining gain.

In some aspects, the scheme described in connection with FIG. 5 may be considered as a global coupled LDPC code. For example, in the scheme described in FIG. 5, the parity CB (e.g., CB C 512) may contain additional parities that correspond to the combination of the systematic CBs (e.g., CB A 502, CB B 504). In other words, the parity CBs (e.g., CB C 512) may form a global coupling among the systematic CBs (e.g., CB A 502, CB B 504) within the same transport block.

Since the specific coupling pattern for the parity CB (e.g., CB C 512) is carried out based on the RV for the parity CB (e.g., RV 2 572) of the underlying LDPC code, these globally coupled LDPC codes may be decoded using the same decoding hardware as used for decoding systematic CBs (e.g., CB A 502, CB B 504), without involving the outer code. In the example in FIG. 5, CB B 504 (or coded bits 544 corresponding to CB B 504) may be decoded using the local connections (e.g., RV 0 570 of CB B 504). Once decoded, this CB (e.g., CB B 504) may be peeled off (or removed) from the global factor graph, for example, through the LLR operations described in Equation (1). The remaining factor graph then effectively becomes the factor graph of RV 0 570 and RV 2 572 of the LDPC code, and this combined graph may be decoded using the hardware used for decoding systematic CBs (e.g., CB A 502, CB B 504).

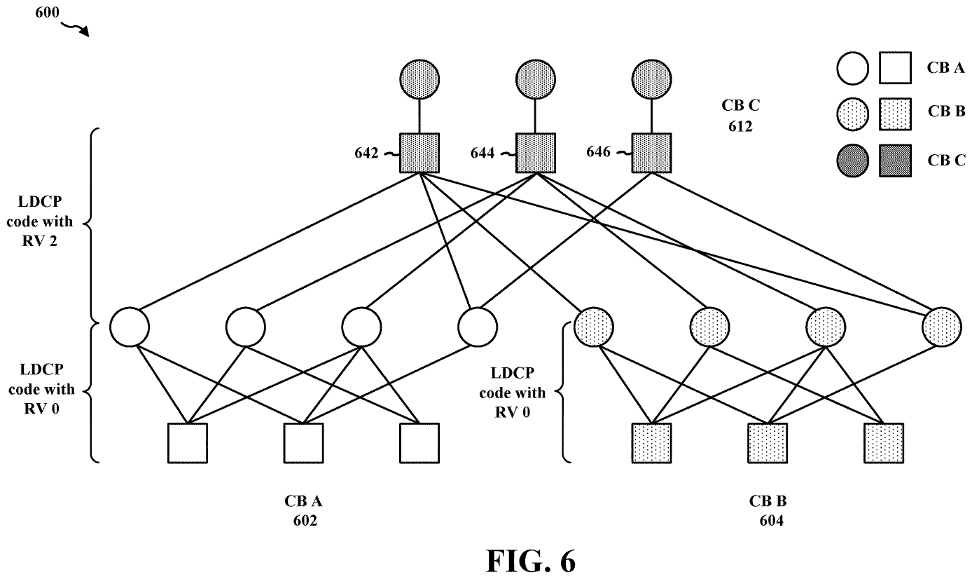

FIG. 6 is a diagram 600 illustrating an example of globally coupled LDPC codes among the CBs in accordance with various aspects of the present disclosure. As shown in FIG. 6, the system CBs, such as CB A 602, CB B 604, may be encoded using the same inner code (e.g., LDCP code), and therefore have the same construction in FIG. 6. The parity CB (e.g., CB C 612) creates additional check nodes (e.g., check nodes 642, 644, 646) that inter-connect the systematic CBs (e.g., CB A 602, CB B 604). That is, a global coupling between the CBs (e.g., CB A 602, CB B 604) has been created via the check nodes (e.g., check nodes 642, 644, 646). On the other hand, in the example of FIG. 4, the systematic CBs (e.g., systematic CBs 402, 404, 406) are independently encoded, and there is no inter-connection between these CBs (e.g., systematic CBs 402, 404, 406). As a result, in the example of FIG. 6, when one CB (e.g., CB A 602) fails to be decoded at the receiver, the receiver can still recover that CB (e.g., CB A 602) by jointly decoding other coupled CBs (e.g., CB B 604, CB C 612). As shown in FIG. 6, when the information associated with CB B 604 has been removed from the graph in FIG. 6, the remaining graph represents the LDCP codes with different RVs (e.g., RV 0 and RV 2). As a result, no additional hardware is needed for the receiver to jointly decode the coupled CBs (e.g., CB B 604, CB C 612) to recover the failed CB (e.g., CB A 602).

In some aspects, the number of coded bits included in the parity code blocks (e.g., CB C 512) may be different from the number of coded bits included in the systematic CBs (e.g., CB A 502, CB B 504). For example, referring to FIG. 5, the number of coded bits included in parity CB C 512 (e.g., at 546) may be different from the number of coded bits included in the systematic CB A 502, CB B 504 (e.g., at 542, 544). For example, the lengths of coded bits corresponding to the parity CBs (e.g., CB C 512) and the systematic CBs (e.g., CB A 502, CB B 504) may be communicated between the transmitter and the receiver using, for example, downlink control information (DCI), radio resource control (RRC), or a medium access control (MAC)-control element (MAC-CE). For example, the length of coded bits corresponding to parity CB C 512 may be shorter than the lengths of coded bits corresponding to systematic CB A 502 and CB B 504 in order to convey additional parities for the failed CBs.

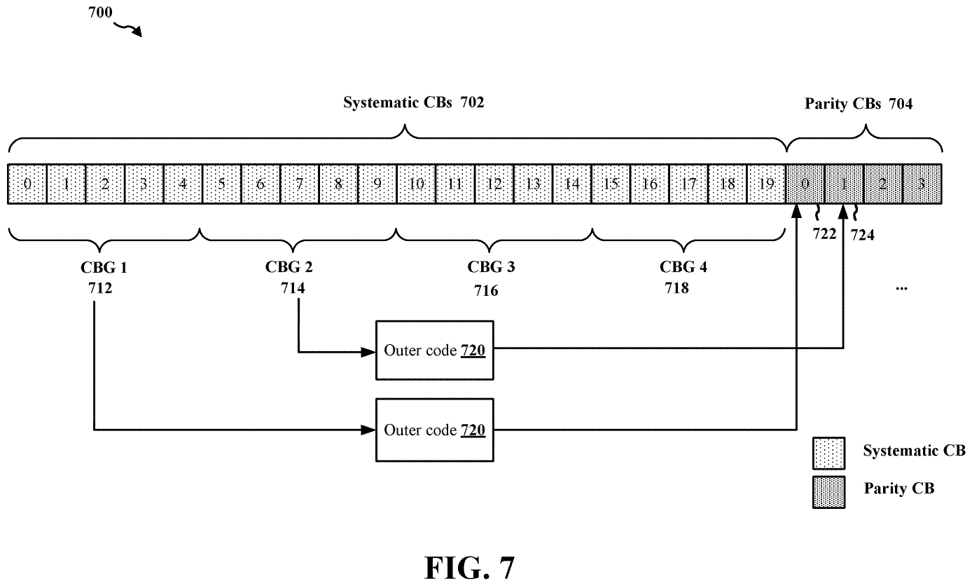

In some aspects, the outer code may be applied within a given code block group (CBG) in case CBG-based feedback is configured or scheduled. A CBG may include multiple CBs. FIG. 7 is a diagram 700 illustrating an example of applying an outer code in CBGs in accordance with aspects of the present disclosure. As shown in FIG. 7, the systematic CBs 702 may first be partitioned into multiple CBGs, such as CBG 1 712, CBG 2 714, CBG 3 716, CBG 4 718. Each of these CBGs may include, for example, five CBs. Then, the outer code may be applied on the CBG level instead of the CB level. For example, outer code 720 may be applied on CBG 1 712 to obtain parity CB 722, and the outer code 720 may be applied on CBG 2 714 to obtain parity CB 724.

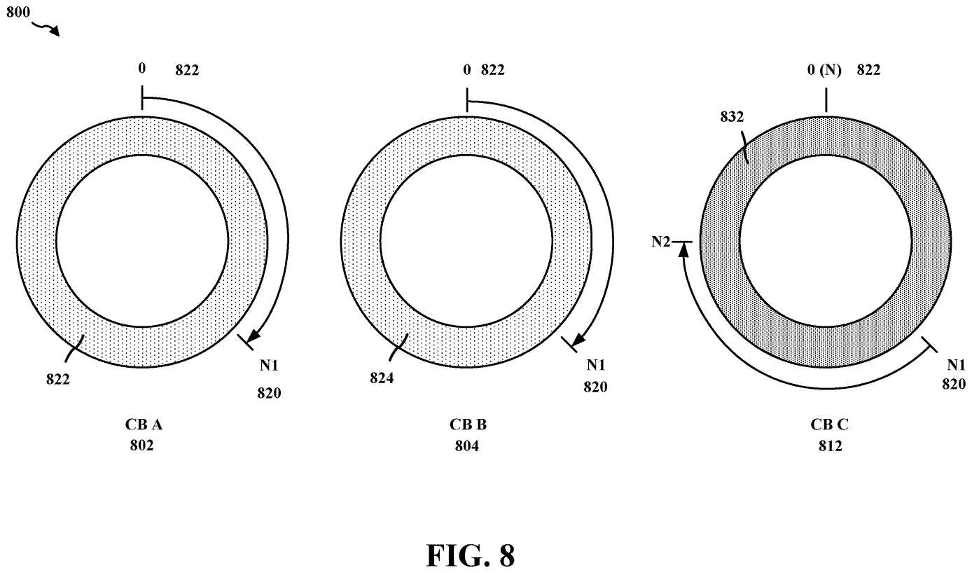

In some aspects, since the systematic code blocks (e.g., CB A 502, CB B 504) and parity CBs (e.g., CB C 512) are transmitted in the same transport block, the starting point of the parity CB (e.g., CB C 512) in the circular buffer may be positioned immediately after the end of the parity bits of the systematic CBs (e.g., CB A 502, CB B 504). FIG. 8 is a diagram 800 illustrating an example of the starting points for the transmission of systematic CBs and parity CBs in circular buffers in accordance with various aspects of the present disclosure. As shown in FIG. 8, suppose the length of the circular buffer (e.g., circular buffer 822 for systematic CB A 802, circular buffer 824 for systematic CB B 804, circular buffer 832 for parity CB C 812) is N. If N1 bits are transmitted for each systematic CB (e.g., CB A 802, CB B 804), then for the parity CB (e.g., CB C 512), the transmitted coded bits in the circular buffer (e.g., circular buffer 832) may start from position N1+1 (e.g., at 820) and extend towards N (e.g., at 822). In some examples, the transmitted coded bits may wrap around in the circular buffer (e.g., circular buffer 832). That is, after reaching the end of the circular buffer (e.g., circular buffer 832), the transmission of the coded bits may continue from the beginning of the circular buffer (e.g., circular buffer 832) until all the coded bits corresponding to the parity CB (e.g., CB C 812) have been transmitted.

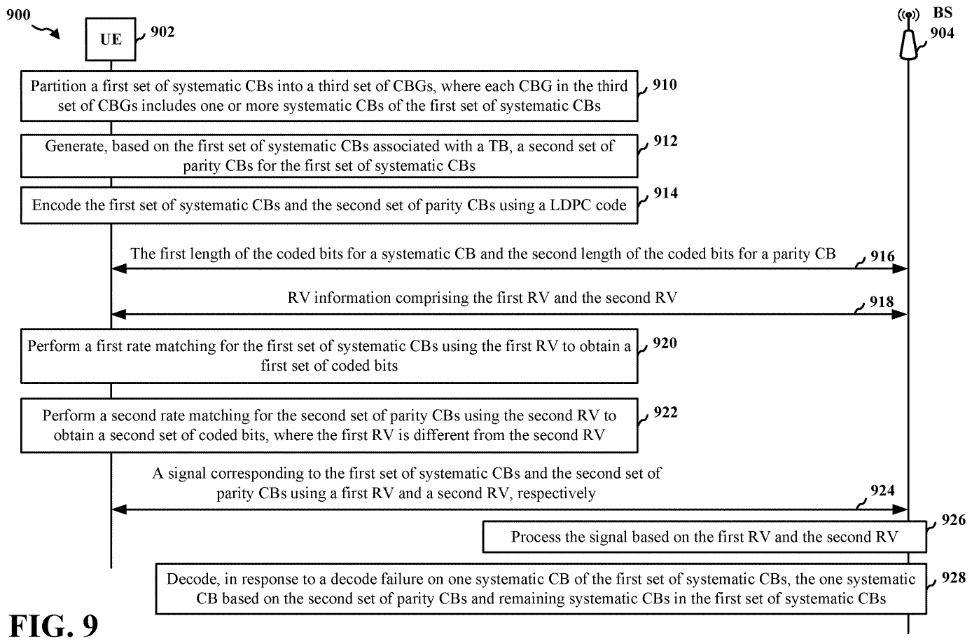

FIG. 9 is a call flow diagram 900 illustrating a method of wireless communication in accordance with various aspects of this present disclosure. Various aspects are described in connection with a UE 902 and a base station 904. The aspects may be performed by the UE 902 or the base station 904 in aggregation and/or by one or more components of a base station 904 (e.g., a CU 110, a DU 130, and/or an RU 140).

As shown in FIG. 9, at 910, the UE 902 may partition the set of systematic CBs into a set of CBGs, and each CBG in the set of CBGs may include one or more systematic CBs of the set of systematic CBs. For example, referring to FIG. 7, the UE may partition the set of systematic CBs 702 into a set of CBGs (e.g., CBG 1 712, CBG 2 714, CBG 3 716, CBG 4 718). Each CBG in the set of CBGs (e.g., CBG 1 712, CBG 2 714, CBG 3 716, CBG 4 718) may include one or more systematic CBs (e.g., five CBs) of the set of systematic CBs. In some examples, the outer code 720 may be applied on the CBG level (instead of the CB level) to obtain the parity CBs 704.

At 912, the UE 902 may generate, based on the set of systematic CBs associated with a TB, a set of parity CBs for the set of systematic CBs. For example, referring to FIG. 5, the UE may generate a set of parity CBs (e.g., CB C 512) for the set of systematic CBs (e.g., CB A 502, CB B 504) based on the set of systematic CBs (e.g., CB A 502, CB B 504) associated with a TB.

At 914, the UE 902 may encode the set of systematic CBs and the set of parity CBs using an LDPC code. For example, referring to FIG. 5, the UE may encode (e.g., via inner code 530) the set of systematic CBs (e.g., CB A 502, CB B 504) and the set of parity CBs (e.g., CB C 512) using an LDPC code.

At 916, the UE 902 may communicate with (e.g., transmit to or receive from) the base station 904 the first length of the coded bits (e.g., at 542, 544) for systematic CBs (e.g., CB A 502, CB B 504) and the second length of the coded bits (e.g., at 546) for parity CBs (e.g., CB C 512). For example, the UE 902 may communicate with the base station 904 via downlink control information (DCI), radio resource control (RRC) signaling, or a medium access control (MAC)-control element (MAC-CE).

At 918, the UE 902 may communicate with (e.g., transmit to or receive from) the base station 904 RV information including the first RV (e.g., RV 0 570) for the systematic CBs (e.g., CB A 502, CB B 504) and the second RV (e.g., RV 2 572) for the parity CBs (e.g., CB C 512).

At 920, the UE 902 may perform a first rate matching for the set of systematic CBs using the first RV to obtain a first set of coded bits. For example, referring to FIG. 5, the UE may perform a first rate matching (e.g., at 560) for the set of systematic CBs (e.g., CB A 502, CB B 504) using the first RV (e.g., RV 0 570) to obtain a first set of coded bits (e.g., at 542, 544).

At 922, the UE 902 may perform a second rate matching for the second set of parity CBs using the second RV to obtain a second set of coded bits, and the first RV may be different from the second RV. For example, referring to FIG. 5, the UE may perform a second rate matching (e.g., at 562) for the second set of parity CBs (e.g., CB C 512) using the second RV (e.g., RV 2 572) to obtain a second set of coded bits (e.g., at 546). The first RV (e.g., RV 0 570) may be different from the second RV (e.g., RV 2 572).

At 924, the UE 902 may communicate with base station 904 a signal corresponding to the set of systematic CBs and the set of parity CBs using a first RV and a second RV, respectively. The first RV indicates a first starting point of the transmission of the first set of systematic CBs and the second RV indicates a second starting point of the transmission of the second set of parity CBs. For example, referring to FIG. 5, the UE may communicate with (transmit to or receive from) base station 904 a signal corresponding to the set of systematic CBs (e.g., CB A 502, CB B 504) and the set of parity CBs (e.g., CB C 512) using the first RV (e.g., RV 0 570) and the second RV (e.g., RV 2 572), respectively. Referring to FIG. 8, the first RV may indicate a first starting point (e.g., 0 822 for CB A 802, CB B 804) of the transmission of the first set of systematic CBs (e.g., CB A 802, CB B 804) and the second RV may indicate a second starting point (e.g., N1 820 for CB C 812) of the transmission of the second set of parity CBs (e.g., CB C 812).

At 926, after receiving the signal from the UE 902, the base station 904 may process the signal based on the first RV (e.g., RV 0 570) and the second RV (e.g., RV 2 572). For example, the base station 904 may process the signal by decoding the signal based on the first RV (e.g., RV 0 570) and the second RV (e.g., RV 2 572).

At 928, upon encountering a decode failure on one systematic CB (e.g., CB A 602) of the set of systematic CBs, the base station 904 may decode the one systematic CB (e.g., CB A 602) based on the set of parity CBs (e.g., CB C 612) and remaining systematic CBs (e.g., CB B 604) in the set of systematic CBs.

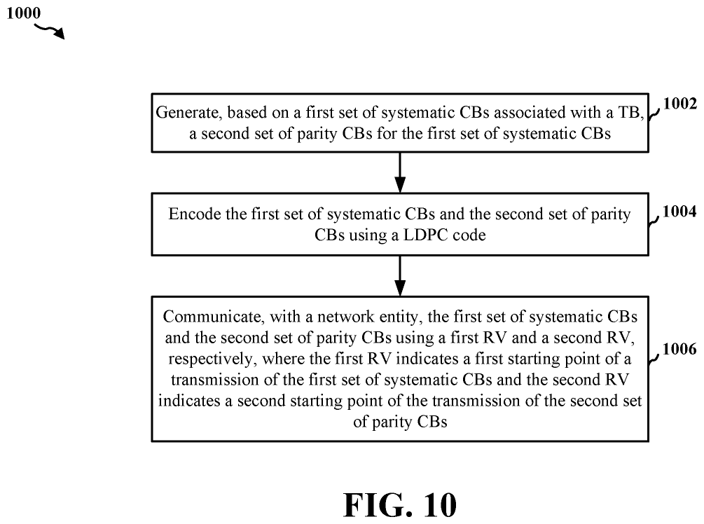

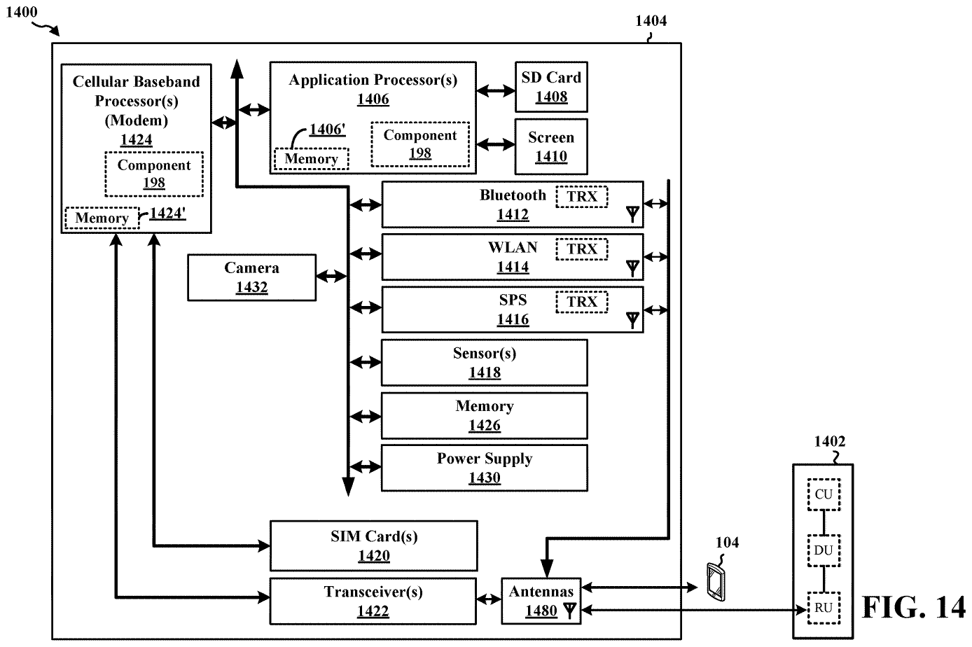

FIG. 10 is a flowchart 1000 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 904; or the network entity 1402 in the hardware implementation of FIG. 14). The UE may be the UE 104, 350, 902, or the apparatus 1404 in the hardware implementation of FIG. 14. By encoding parity CBs using the same LDPC code and assigning different RVs, the methods enable soft-combining across systematic and parity CBs, thereby allowing the receiver to leverage multiple RVs for incremental redundancy gain and improving decoding success rates even when some CBs are lost or corrupted. Additionally, by allowing variable-length parity CBs (e.g., shorter than systematic CBs), the methods provide flexibility in resource allocation and overhead control, thereby improving the efficiency of the overall transmission based on network conditions and transmission priorities.

As shown in FIG. 10, at 1002, the UE may generate, based on a first set of systematic CBs associated with a TB, a second set of parity CBs for the first set of systematic CBs. FIG. 5, FIG. 6, FIG. 7, FIG. 8, and FIG. 9 illustrate various aspects of the steps in connection with flowchart 1000. For example, referring to FIG. 9, the UE 902 may, at 912, generate a second set of parity CBs for the first set of systematic CBs based on a first set of systematic CBs associated with a TB. Referring to FIG. 5, the UE may generate a set of parity CBs (e.g., CB C 512) for the set of systematic CBs (e.g., CB A 502, CB B 504) via outer code 520 based on the set of systematic CBs (e.g., CB A 502, CB B 504) associated with a TB. In some aspects, 1002 may be performed by the encode component 198.

At 1004, the UE may encode the first set of systematic CBs and the second set of parity CBs using an LDPC code. For example, referring to FIG. 9, the UE 902 may, at 914, encode the first set of systematic CBs and the second set of parity CBs using an LDPC code. Referring to FIG. 5, the UE may encode (e.g., via inner code 530) the set of systematic CBs (e.g., CB A 502, CB B 504) and the set of parity CBs (e.g., CB C 512) using an LDPC code. In some aspects, 1004 may be performed by the encode component 198.

At 1006, the UE may communicate with the network entity the first set of systematic CBs and the second set of parity CBs using a first RV and a second RV, respectively. The first RV may indicate a first starting point of the transmission of the first set of systematic CBs, and the second RV may indicate a second starting point of the transmission of the second set of parity CBs. For example, referring to FIG. 9, the UE 902 may, at 924, communicate with the network entity (e.g., base station 904) the first set of systematic CBs and the second set of parity CBs using a first RV and a second RV, respectively. Referring to FIG. 8, the first RV may indicate a first starting point (e.g., 0 822 for CB A 802, CB B 804) of the transmission of the first set of systematic CBs (e.g., CB A 802, CB B 804) and the second RV may indicate a second starting point (e.g., N1 820 for CB C 812) of the transmission of the second set of parity CBs (e.g., CB C 812). In some aspects, 1006 may be performed by the encode component 198.

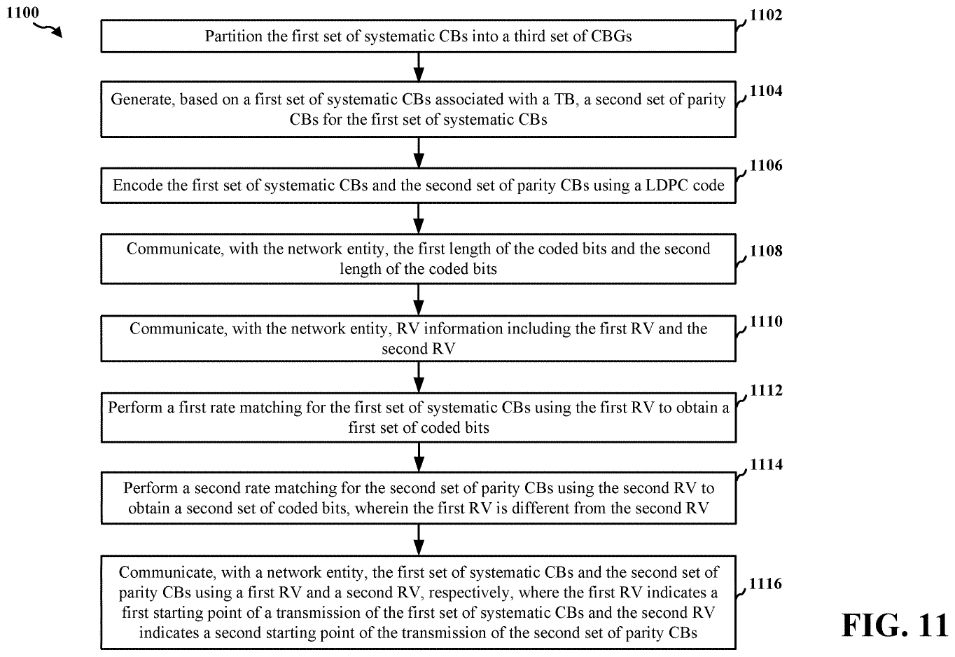

FIG. 11 is a flowchart 1100 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 904; or the network entity 1402 in the hardware implementation of FIG. 14). The UE may be the UE 104, 350, 902, or the apparatus 1404 in the hardware implementation of FIG. 14. By encoding parity CBs using the same LDPC code and assigning different RVs, the methods enable soft-combining across systematic and parity CBs, thereby allowing the receiver to leverage multiple RVs for incremental redundancy gain and improving decoding success rates even when some CBs are lost or corrupted. Additionally, by allowing variable-length parity CBs (e.g., shorter than systematic CBs), the methods provide flexibility in resource allocation and overhead control, thereby improving the efficiency of the overall transmission based on network conditions and transmission priorities.

As shown in FIG. 11, at 1104, the UE may generate, based on a first set of systematic CBs associated with a TB, a second set of parity CBs for the first set of systematic CBs. FIG. 5, FIG. 6, FIG. 7, FIG. 8, and FIG. 9 illustrate various aspects of the steps in connection with flowchart 1100. For example, referring to FIG. 9, the UE 902 may, at 912, generate a second set of parity CBs for the first set of systematic CBs based on a first set of systematic CBs associated with a TB. Referring to FIG. 5, the UE may generate a set of parity CBs (e.g., CB C 512) for the set of systematic CBs (e.g., CB A 502, CB B 504) via outer code 520 based on the set of systematic CBs (e.g., CB A 502, CB B 504) associated with a TB. In some aspects, 1104 may be performed by the encode component 198.

At 1106, the UE may encode the first set of systematic CBs and the second set of parity CBs using an LDPC code. For example, referring to FIG. 9, the UE 902 may, at 914, encode the first set of systematic CBs and the second set of parity CBs using an LDPC code. Referring to FIG. 5, the UE may encode (e.g., via inner code 530) the set of systematic CBs (e.g., CB A 502, CB B 504) and the set of parity CBs (e.g., CB C 512) using an LDPC code (e.g., inner code 530). In some aspects, 1106 may be performed by the encode component 198.

At 1116, the UE may communicate with the network entity the first set of systematic CBs and the second set of parity CBs using a first RV and a second RV, respectively. The first RV may indicate a first starting point of the transmission of the first set of systematic CBs, and the second RV may indicate a second starting point of the transmission of the second set of parity CBs. For example, referring to FIG. 9, the UE 902 may, at 924, communicate with the network entity (e.g., base station 904) the first set of systematic CBs and the second set of parity CBs using a first RV and a second RV, respectively. Referring to FIG. 8, the first RV may indicate a first starting point (e.g., 0 822 for CB A 802, CB B 804) of the transmission of the first set of systematic CBs (e.g., CB A 802, CB B 804) and the second RV may indicate a second starting point (e.g., N1 820 for CB C 812) of the transmission of the second set of parity CBs (e.g., CB C 812). In some aspects, 1116 may be performed by the encode component 198.

In some aspects, at 1112, the UE may perform a first rate matching for the first set of systematic CBs using the first RV to obtain a first set of coded bits. For example, referring to FIG. 9, the UE 902 may, at 920, perform a first rate matching for the first set of systematic CBs using the first RV to obtain a first set of coded bits. Referring to FIG. 5, the UE may perform a first rate matching (e.g., at 560) for the set of systematic CBs (e.g., CB A 502, CB B 504) using the first RV (e.g., RV 0 570) to obtain a first set of coded bits (e.g., at 542, 544). In some aspects, 1112 may be performed by the encode component 198.

In some aspects, at 1114, the UE may perform a second rate matching for the second set of parity CBs using the second RV to obtain a second set of coded bits. The first RV may be different from the second RV. For example, referring to FIG. 9, the UE 902 may, at 922, perform a second rate matching for the second set of parity CBs using the second RV to obtain a second set of coded bits. Referring to FIG. 5, the UE may perform a second rate matching (e.g., at 562) for the second set of parity CBs (e.g., CB C 512) using the second RV (e.g., RV 2 572) to obtain a second set of coded bits (e.g., at 546). The first RV (e.g., RV 0 570) may be different from the second RV (e.g., RV 2 572). In some aspects, 1114 may be performed by the encode component 198.

In some aspects, to communicate the first set of systematic CBs and the second set of parity CBs (e.g., at 1116), the UE may communicate with the network entity the first set of coded bits and the second set of coded bits. For example, referring to FIG. 5, the UE may communicate with the network entity the first set of coded bits (e.g., at 542, 544) for the systematic CBs (e.g., CB A 502, CB B 504) and the second set of coded bits (e.g., 546) for the parity CBs (e.g., CB C 512).

In some aspects, to generate the second set of parity CBs for the first set of systematic CBs (e.g., at 1104), the UE may generate the second set of parity CBs using a bit-wise XOR operation between the systematic CBs of the first set of systematic CBs. For example, referring to FIG. 5, the UE may generate the second set of parity CBs (e.g., CB C 512) using a bit-wise XOR operation between the systematic CBs (e.g., CB A 502, CB B 504) of the first set of systematic CBs.

In some aspects, a first length of coded bits for a systematic CB may be different from a second length of coded bits for a parity CB. For example, referring to FIG. 5, a first length of coded bits (e.g., at 542, 544) for a systematic CB (e.g., CB A 502, CB B 504) may be different from a second length of coded bits (e.g., at 546) for a parity CB (e.g., CB C 512).

In some aspects, the first length of the coded bits may be longer than the second length of the coded bits. For example, referring to FIG. 5, the first length of the coded bits (e.g., at 542, 544) may be longer than the second length of the coded bits (e.g., at 546).

In some aspects, at 1108, the UE may communicate with the network entity the first length of the coded bits and the second length of the coded bits. For example, referring to FIG. 9, the UE 902 may, at 916, communicate with the network entity (e.g., base station 904) the first length of the coded bits and the second length of the coded bits. In some aspects, 1108 may be performed by the encode component 198.

In some aspects, the UE may communicate the first length of the coded bits and the second length of the coded bits (e.g., at 1108) via one or more of: downlink control information (DCI), radio resource control (RRC) signaling, or a medium access control (MAC)-control element (MAC-CE). For example, referring to FIG. 9, the UE 902 may, at 916, communicate with base station 904 the first length of the coded bits and the second length of the coded bits via one or more of: DCI, RRC signaling, or a MAC-CE.

In some aspects, at 1102, the UE may partition the first set of systematic CBs into a third set of CBGs, and each CBG in the third set of CBGs may include one or more systematic CBs of the first set of systematic CBs. The UE may generate the second set of parity CBs for the first set of systematic CBs (e.g., at 1104), so that each parity CB of the second set of parity CBs corresponds to one CBG of the third set of CBGs. For example, referring to FIG. 9, the UE 902 may, at 910, partition the first set of systematic CBs into a third set of CBGs, and each CBG in the third set of CBGs may include one or more systematic CBs of the first set of systematic CBs. Referring to FIG. 7, the UE may generate the second set of parity CBs 704 for the first set of systematic CBs 702, so that each parity CB (e.g., 722) of the second set of parity CBs corresponds to one CBG (e.g., CBG 1 712) of the third set of CBGs. In some aspects, 1102 may be performed by the encode component 198.

In some aspects, the second RV may be based on an end point of the transmission of the first set of systematic CBs. For example, referring to FIG. 8, the second RV (e.g., N1 820) may be based on an end point of the transmission of the first set of systematic CBs (e.g., CB A 802, CB B 804).

In some aspects, the second set of parity CBs may be arranged in a circular buffer, and the second set of coded bits includes a wraparound portion of the second set of parity CBs at the beginning of the circular buffers. For example, referring to FIG. 8, the second set of parity CBs may be arranged in a circular buffer (e.g., circular buffer 832), and the second set of coded bits includes a wraparound portion of the second set of parity CBs at the beginning of the circular buffers (e.g., circular buffer 832).

In some aspects, to communicate with the network entity the first set of systematic CBs and the second set of parity CBs using the first RV and the second RV, respectively (e.g., at 1110), the UE may transmit, to the network entity, a signal corresponding to the first set of systematic CBs and the second set of parity CBs using the first RV and the second RV, respectively. For example, referring to FIG. 9, the UE 902 may, at 924, transmit to the network entity (e.g., base station 904) a signal corresponding to the first set of systematic CBs and the second set of parity CBs using the first RV and the second RV, respectively.

In some aspects, at 1110, the UE may communicate with the network entity RV information including the first RV and the second RV via one or more of: DCI, RRC signaling, or a MAC-CE. For example, referring to FIG. 9, the UE 902 may, at 918, communicate with the network entity (e.g., base station 904) RV information including the first RV and the second RV via one or more of: DCI, RRC signaling, or a MAC-CE. In some aspects, 1110 may be performed by the encode component 198.

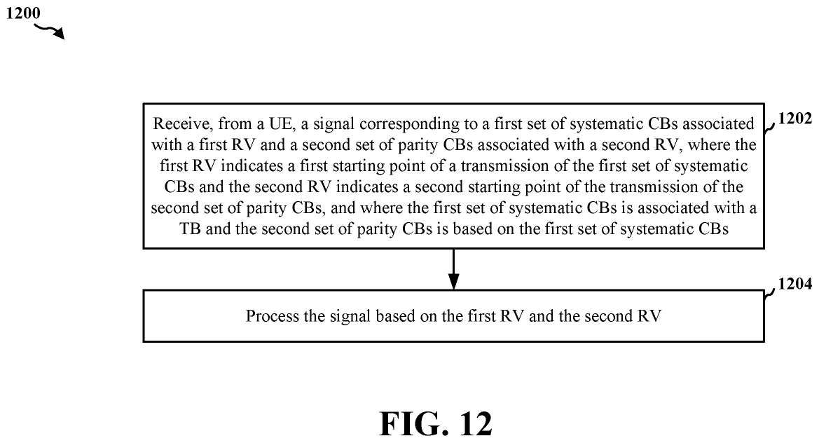

FIG. 12 is a flowchart 1200 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 904; or the network entity 1402 in the hardware implementation of FIG. 14). The UE may be the UE 104, 350, 902, or the apparatus 1404 in the hardware implementation of FIG. 14. By encoding parity CBs using the same LDPC code and assigning different RVs, the methods enable soft-combining across systematic and parity CBs, thereby allowing the receiver to leverage multiple RVs for incremental redundancy gain and improving decoding success rates even when some CBs are lost or corrupted. Additionally, by allowing variable-length parity CBs (e.g., shorter than systematic CBs), the methods provide flexibility in resource allocation and overhead control, thereby improving the efficiency of the overall transmission based on network conditions and transmission priorities.

As shown in FIG. 12, at 1202, the network entity may receive, from a UE, a signal corresponding to a first set of systematic CBs associated with a first RV and a second set of parity CBs associated with a second RV. The first RV indicates a first starting point of the transmission of the first set of systematic CBs and the second RV indicates a second starting point of the transmission of the second set of parity CBs, and the first set of systematic CBs is associated with a TB and the second set of parity CBs is based on the first set of systematic CBs. FIG. 5, FIG. 6, FIG. 7, FIG. 8, and FIG. 9 illustrate various aspects of the steps in connection with flowchart 1200. For example, referring to FIG. 9, the network entity (e.g., base station 904) may, at 924, receive from a UE 902 a signal corresponding to a first set of systematic CBs associated with a first RV and a second set of parity CBs associated with a second RV. Referring to FIG. 8, the first RV (e.g., 0 822) indicates a first starting point of the transmission of the first set of systematic CBs (e.g., CB A 802, CB B 804) and the second RV (e.g., N1 820) indicates a second starting point of the transmission of the second set of parity CBs (e.g., CB C 812), and the first set of systematic CBs is associated with a TB and the second set of parity CBs is based on the first set of systematic CBs. In some aspects, 1202 may be performed by the encode component 199.

At 1204, the network entity may process the signal based on the first RV and the second RV. For example, referring to FIG. 9, the network entity (e.g., base station 904) may, at 926, process the signal based on the first RV and the second RV. In some aspects, 1204 may be performed by the encode component 199.

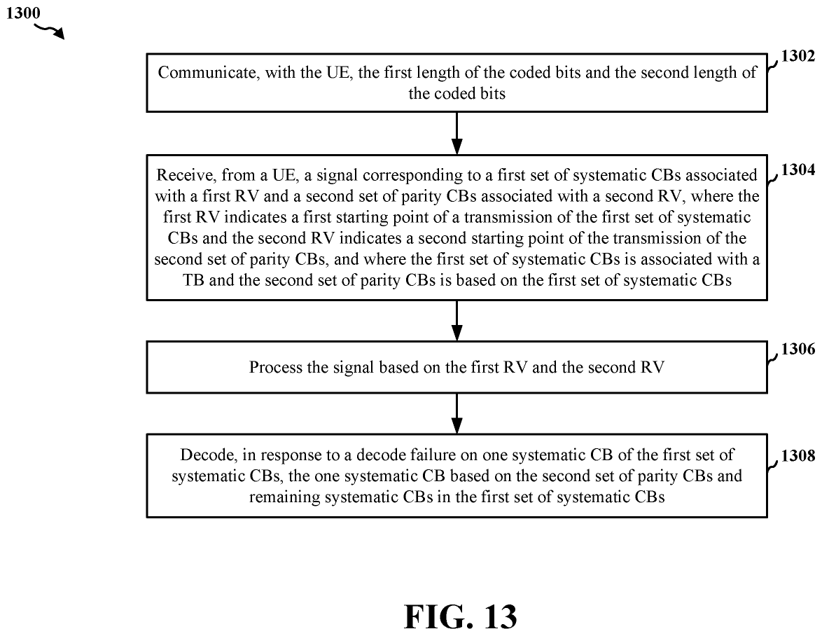

FIG. 13 is a flowchart 1300 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 904; or the network entity 1402 in the hardware implementation of FIG. 14). The UE may be the UE 104, 350, 902, or the apparatus 1404 in the hardware implementation of FIG. 14. By encoding parity CBs using the same LDPC code and assigning different RVs, the methods enable soft-combining across systematic and parity CBs, thereby allowing the receiver to leverage multiple RVs for incremental redundancy gain and improving decoding success rates even when some CBs are lost or corrupted. Additionally, by allowing variable-length parity CBs (e.g., shorter than systematic CBs), the methods provide flexibility in resource allocation and overhead control, thereby improving the efficiency of the overall transmission based on network conditions and transmission priorities.

As shown in FIG. 13, at 1304, the network entity may receive, from a UE, a signal corresponding to a first set of systematic CBs associated with a first RV and a second set of parity CBs associated with a second RV. The first RV indicates a first starting point of the transmission of the first set of systematic CBs and the second RV indicates a second starting point of the transmission of the second set of parity CBs, and the first set of systematic CBs is associated with a TB and the second set of parity CBs is based on the first set of systematic CBs. FIG. 5, FIG. 6, FIG. 7, FIG. 8, and FIG. 9 illustrate various aspects of the steps in connection with flowchart 1300. For example, referring to FIG. 9, the network entity (e.g., base station 904) may, at 924, receive from a UE 902 a signal corresponding to a first set of systematic CBs associated with a first RV and a second set of parity CBs associated with a second RV. Referring to FIG. 8, the first RV (e.g., 0 822) indicates a first starting point of the transmission of the first set of systematic CBs (e.g., CB A 802, CB B 804) and the second RV (e.g., N1 820) indicates a second starting point of the transmission of the second set of parity CBs (e.g., CB C 812), and the first set of systematic CBs is associated with a TB and the second set of parity CBs is based on the first set of systematic CBs. In some aspects, 1304 may be performed by the encode component 199.

At 1306, the network entity may process the signal based on the first RV and the second RV. For example, referring to FIG. 9, the network entity (e.g., base station 904) may, at 926, process the signal based on the first RV and the second RV. In some aspects, 1306 may be performed by the encode component 199.

In some aspects, the signal may include a first set of coded bits and a second set of coded bits. The first set of coded bits is based on a first rate matching for the first set of systematic CBs using the first RV and the second set of coded bits is based on a second rate matching for the second set of parity CBs using the second RV, and the first RV is different from the second RV. For example, referring to FIG. 5, the UE may perform a first rate matching (e.g., at 560) for the set of systematic CBs (e.g., CB A 502, CB B 504) using the first RV (e.g., RV 0 570) to obtain a first set of coded bits (e.g., at 542, 544). The UE may perform a second rate matching (e.g., at 562) for the second set of parity CBs (e.g., CB C 512) using the second RV (e.g., RV 2 572) to obtain a second set of coded bits (e.g., at 546). The first RV (e.g., RV 0 570) may be different from the second RV (e.g., RV 2 572).

In some aspects, to process the signal based on the first RV and the second RV (e.g., at 1306), the network entity may decode the signal based on the first RV and the second RV. For example, referring to FIG. 9, to process the signal based on the first RV and the second RV (e.g., at 926), the network entity (e.g., base station 904) may decode the signal based on the first RV and the second RV.

In some aspects, at 1308, the network entity may decode, in response to a decode failure on one systematic CB of the first set of systematic CBs, the one systematic CB based on the second set of parity CBs and the remaining systematic CBs in the first set of systematic CBs. For example, referring to FIG. 9, the network entity (e.g., base station 904) may, at 928, decode, in response to a decode failure on one systematic CB of the first set of systematic CBs, the one systematic CB based on the second set of parity CBs and the remaining systematic CBs in the first set of systematic CBs. In some aspects, 1308 may be performed by the encode component 199.

In some aspects, to decode the one systematic CB based on the second set of parity CBs and the remaining systematic CBs in the first set of systematic CBs (e.g., at 1308), the network entity may obtain a first log-likelihood ratio (LLR) of the one systematic CB corresponding to the first RV and a second LLR of the one systematic CB corresponding to the second RV; and decode the one systematic CB based on the first LLR and the second LLR. For example, referring to FIG. 9 and Equation (1), to decode the one systematic CB based on the second set of parity CBs and the remaining systematic CBs in the first set of systematic CBs (e.g., at 928), the network entity (e.g., base station 904) may obtain a first LLR of the one systematic CB (e.g., CB A 502) corresponding to the first RV (e.g., RV 0 570) and a second LLR of the one systematic CB (e.g., CB A 502) corresponding to the second RV (e.g., RV 2 572); and decode the one systematic CB (e.g., CB A 502) based on the first LLR and the second LLR.

In some aspects, a first length of coded bits for a systematic CB may be different from a second length of coded bits for a parity CB. For example, referring to FIG. 5, a first length of coded bits (e.g., at 542, 544) for a systematic CB (e.g., CB A 502, CB B 504) may be different from a second length of coded bits (e.g., at 546) for a parity CB (e.g., CB C 512).

In some aspects, the first length of the coded bits may be longer than the second length of the coded bits. For example, referring to FIG. 5, the first length of the coded bits (e.g., at 542, 544) may be longer than the second length of the coded bits (e.g., at 546).

In some aspects, at 1302, the network entity may communicate with the UE the first length of the coded bits and the second length of the coded bits. For example, referring to FIG. 9, the network entity (e.g., base station 904) may, at 916, communicate with the UE 902 the first length of the coded bits and the second length of the coded bits. In some aspects, 1302 may be performed by the encode component 199.

In some aspects, the second RV may be based on an end point of the transmission of the first set of systematic CBs. For example, referring to FIG. 8, the second RV (e.g., N1 820) may be based on an end point of the transmission of the first set of systematic CBs (e.g., CB A 802, CB B 804).

In some aspects, the second set of parity CBs may be arranged in a circular buffer, and the second set of coded bits includes a wraparound portion of the second set of parity CBs at the beginning of the circular buffer. For example, referring to FIG. 8, the second set of parity CBs (e.g., CB C 812) may be arranged in a circular buffer (e.g., circular buffer 832), and the second set of coded bits includes a wraparound portion of the second set of parity CBs at the beginning of the circular buffer (e.g., circular buffer 832).

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor (or processing circuitry) 1424 (also referred to as a modem) coupled to one or more transceivers 1422 (e.g., cellular RF transceivers). The cellular baseband processor(s) (or processing circuitry) 1424 may include at least one on-chip memory (or memory circuitry) 1424′. In some aspects, the apparatus 1404 may further include one or more subscriber identity modules (SIM) cards 1420 and at least one application processor (or processing circuitry) 1406 coupled to a secure digital (SD) card 1408 and a screen 1410. The application processor(s) (or processing circuitry) 1406 may include on-chip memory (or memory circuitry) 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) (or processing circuitry) 1424 communicates through the transceiver(s) 1422 via one or more antennas 1480 with the UE 104 and/or with an RU associated with a network entity 1402. The cellular baseband processor(s) (or processing circuitry) 1424 and the application processor(s) (or processing circuitry) 1406 may each include a computer-readable medium/memory (or memory circuitry) 1424′, 1406′, respectively. The additional memory modules 1426 may also be considered a computer-readable medium/memory (or memory circuitry). Each computer-readable medium/memory (or memory circuitry) 1424′, 1406′, 1426 may be non-transitory. The cellular baseband processor(s) (or processing circuitry) 1424 and the application processor(s) (or processing circuitry) 1406 are each responsible for general processing, including the execution of software stored on the computer-readable medium/memory (or memory circuitry). The software, when executed by the cellular baseband processor(s) (or processing circuitry) 1424/application processor(s) (or processing circuitry) 1406, causes the cellular baseband processor(s) (or processing circuitry) 1424/application processor(s) (or processing circuitry) 1406 to perform the various functions described supra. The cellular baseband processor(s) (or processing circuitry) 1424 and the application processor(s) (or processing circuitry) 1406 are configured to perform the various functions described supra based at least in part on the information stored in the memory (or memory circuitry). That is, the cellular baseband processor(s) (or processing circuitry) 1424 and the application processor(s) (or processing circuitry) 1406 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1424/application processor(s) (or processing circuitry) 1406 when executing software. The cellular baseband processor(s) (or processing circuitry) 1424/application processor(s) (or processing circuitry) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) (or processing circuitry) 1424 and/or the application processor(s) (or processing circuitry) 1406, and in another configuration, the apparatus 1404 may be the entire UE (e.g., see UE 350 of FIG. 3) and include the additional modules of the apparatus 1404.

As discussed supra, the component 198 may be configured to generate, based on a first set of systematic CBs associated with a TB, a second set of parity CBs for the first set of systematic CBs; encode the first set of systematic CBs and the second set of parity CBs using an LDPC code; and communicate with a network entity the first set of systematic CBs and the second set of parity CBs using a first RV and a second RV, respectively, where the first RV indicates a first starting point of the transmission of the first set of systematic CBs and the second RV indicates a second starting point of the transmission of the second set of parity CBs. The component 198 may be further configured to perform any of the aspects described in connection with the flowcharts in FIG. 10 and FIG. 11, and/or performed by the UE 902 in FIG. 9. The component 198 may be within the cellular baseband processor(s) (or processing circuitry) 1424, the application processor(s) (or processing circuitry) 1406, or both the cellular baseband processor(s) (or processing circuitry) 1424 and the application processor(s) (or processing circuitry) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) (or processing circuitry) 1424 and/or the application processor(s) (or processing circuitry) 1406, includes means for generating, based on a first set of systematic CBs associated with a TB, a second set of parity CBs for the first set of systematic CBs; means for encoding the first set of systematic CBs and the second set of parity CBs using an LDPC code; and means for communicating, with a network entity, the first set of systematic CBs and the second set of parity CBs using a first RV and a second RV, respectively, where the first RV indicates a first starting point of the transmission of the first set of systematic CBs and the second RV indicates a second starting point of the transmission of the second set of parity CBs. The apparatus 1404 may further include means for performing any of the aspects described in connection with the flowcharts in FIG. 10 and FIG. 11, and/or aspects performed by the UE 902 in FIG. 9. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

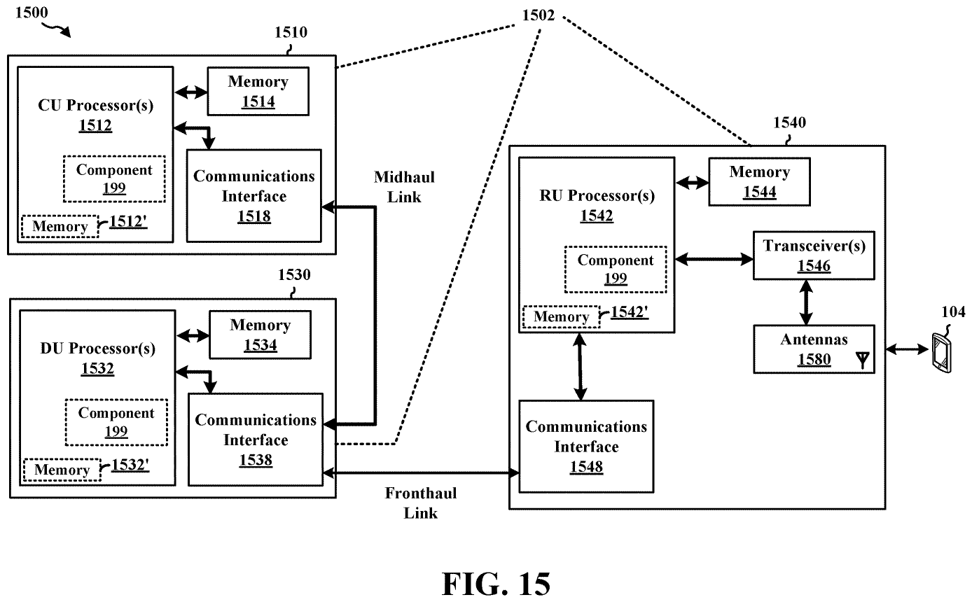

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor (or processing circuitry) 1512. The CU processor(s) (or processing circuitry) 1512 may include on-chip memory (or memory circuitry) 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor (or processing circuitry) 1532. The DU processor(s) (or processing circuitry) 1532 may include on-chip memory (or memory circuitry) 1532′. In some aspects, the DU 1530 may further include additional memory modules 1534 and a communications interface 1538. The DU 1530 communicates with the RU 1540 through a fronthaul link. The RU 1540 may include at least one RU processor (or processing circuitry) 1542. The RU processor(s) (or processing circuitry) 1542 may include on-chip memory (or memory circuitry) 1542′.

In some aspects, the RU 1540 may further include additional memory modules 1544, one or more transceivers 1546, antennas 1580, and a communications interface 1548. The RU 1540 communicates with the UE 104. The on-chip memory (or memory circuitry) 1512′, 1532′, 1542′ and the additional memory modules 1514, 1534, 1544 may each be considered a computer-readable medium/memory (or memory circuitry). Each computer-readable medium/memory (or memory circuitry) may be non-transitory. Each of the processors (or processing circuitry) 1512, 1532, 1542 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to receive, from a UE, a signal corresponding to a first set of systematic CBs associated with a first RV and a second set of parity CBs associated with a second RV, where the first RV indicates a first starting point of the transmission of the first set of systematic CBs and the second RV indicates a second starting point of the transmission of the second set of parity CBs, and where the first set of systematic CBs is associated with a TB and the second set of parity CBs is based on the first set of systematic CBs; and process the signal based on the first RV and the second RV. The component 199 may be further configured to perform any of the aspects described in connection with the flowcharts in FIG. 12 and FIG. 13, and/or performed by the base station 904 in FIG. 9. The component 199 may be within one or more processors (or processing circuitry) of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 includes means for receiving, from a UE, a signal corresponding to a first set of systematic CBs associated with a first RV and a second set of parity CBs associated with a second RV, where the first RV indicates a first starting point of the transmission of the first set of systematic CBs and the second RV indicates a second starting point of the transmission of the second set of parity CBs, and where the first set of systematic CBs is associated with a TB and the second set of parity CBs is based on the first set of systematic CBs; and means for processing the signal based on the first RV and the second RV. The network entity 1502 may further include means for performing any of the aspects described in connection with the flowcharts in FIG. 12 and FIG. 13, and/or aspects performed by the base station 904 in FIG. 9. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include generating, based on a first set of systematic CBs associated with a TB, a second set of parity CBs for the first set of systematic CBs; encoding the first set of systematic CBs and the second set of parity CBs using an LDPC code; and communicating, with a network entity, the first set of systematic CBs and the second set of parity CBs using a first RV and a second RV, respectively. The first RV indicates a first starting point of the transmission of the first set of systematic CBS, and the second RV indicates a second starting point of the transmission of the second set of parity CBs. By encoding parity CBs using the same LDPC code and assigning different RVs, the methods enable soft-combining across systematic and parity CBS, thereby allowing the receiver to leverage multiple RVs for incremental redundancy gain and improving decoding success rates even when some CBs are lost or corrupted. Additionally, by allowing variable-length parity CBs (e.g., shorter than systematic CBs), the methods provide flexibility in resource allocation and overhead control, thereby improving the efficiency of the overall transmission based on network conditions and transmission priorities.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.”

The following aspects are illustrative only and may be combined with other aspects or teachings described herein, without limitation.

Aspect 1 is a method of wireless communication at a UE. The method includes generating, based on a first set of systematic code blocks (CBs) associated with a transport block (TB), a second set of parity CBs for the first set of systematic CBs; encoding the first set of systematic CBs and the second set of parity CBs using a low-density parity-check (LDPC) code; and communicating, with a network entity, the first set of systematic CBs and the second set of parity CBs using a first redundancy version (RV) and a second RV, respectively, wherein the first RV indicates a first starting point of a transmission of the first set of systematic CBs and the second RV indicates a second starting point of the transmission of the second set of parity CBs.

Aspect 2 is the method of aspect 1, wherein the method further includes performing a first rate matching for the first set of systematic CBs using the first RV to obtain a first set of coded bits; and performing a second rate matching for the second set of parity CBs using the second RV to obtain a second set of coded bits, wherein the first RV is different from the second RV, and wherein communicating, with the network entity, the first set of systematic CBs and the second set of parity CBs comprises: communicating, with the network entity, the first set of coded bits and the second set of coded bits.

Aspect 3 is the method of any of aspects 1 to 2, wherein generating the second set of parity CBs for the first set of systematic CBs comprises: generating the second set of parity CBs using a bit-wise exclusive OR (XOR) operation between the systematic CBs of the first set of systematic CBs.

Aspect 4 is the method of any of aspects 1 to 2, wherein a first length of coded bits for a systematic CB is different from a second length of coded bits for a parity CB.

Aspect 5 is the method of aspect 4, wherein the first length of the coded bits is longer than the second length of the coded bits.

Aspect 6 is the method of aspect 4, wherein the method further includes communicating, with the network entity, the first length of the coded bits and the second length of the coded bits.

Aspect 7 is the method of aspect 6, wherein communicating the first length of the coded bits and the second length of the coded bits comprises: communicating the first length of the coded bits and the second length of the coded bits via one or more of: downlink control information (DCI); radio resource control (RRC) signaling; or a medium access control (MAC)-control element (MAC-CE).

Aspect 8 is the method of any of aspects 1 to 7, wherein the method further includes partitioning the first set of systematic CBs into a third set of code block groups (CBGs), wherein each CBG in the third set of CBGs includes one or more systematic CBs of the first set of systematic CBs, and wherein generating the second set of parity CBs for the first set of systematic CBs comprises: generating the second set of parity CBs based on the third set of CBGs, wherein each parity CB of the second set of parity CBs corresponds to one CBG of the third set of CBGs.

Aspect 9 is the method of any of aspects 1 to 8, wherein the second RV is based on an end point of the transmission of the first set of systematic CBs.

Aspect 10 is the method of aspect 9, wherein the second set of parity CBs is arranged in a circular buffer, and wherein the second set of coded bits includes a wraparound portion of the second set of parity CBs at a beginning of the circular buffer.

Aspect 11 is the method of any of aspects 1 to 10, wherein communicating, with the network entity, the first set of systematic CBs and the second set of parity CBs using the first RV and the second RV, respectively comprises: transmitting, to the network entity, a signal corresponding to the first set of systematic CBs and the second set of parity CBs using the first RV and the second RV, respectively.

Aspect 12 is the method of any of aspects 1 to 11, wherein the method further includes communicating, with the network entity, RV information comprising the first RV and the second RV via one or more of: downlink control information (DCI); radio resource control (RRC) signaling; or a medium access control (MAC)-control element (MAC-CE).

Aspect 13 is an apparatus for wireless communication at a UE, comprising: at least one memory; and at least one processor coupled to the at least one memory, the at least one processor is configured to perform the method of any of aspects 1 to 12.

Aspect 14 is the apparatus for wireless communication at a UE, comprising means for performing each step in the method of any of aspects 1-12.

Aspect 15 is an apparatus of any of aspects 13-14, further comprising a transceiver configured to receive or to transmit in association with the method of any of aspects 1-12.

Aspect 16 is a computer-readable medium (e.g., a non-transitory computer-readable medium) storing computer executable code at a UE, the code when executed by at least one processor causes the at least one processor to perform the method of any of aspects 1-12.

Aspect 17 is a method of wireless communication at a network entity. The method includes receiving, from a user equipment (UE), a signal corresponding to a first set of systematic code blocks (CBs) associated with a first redundancy version (RV) and a second set of parity CBs associated with a second RV, wherein the first RV indicates a first starting point of a transmission of the first set of systematic CBs and the second RV indicates a second starting point of the transmission of the second set of parity CBs, and wherein the first set of systematic CBs is associated with a transport block (TB) and the second set of parity CBs is based on the first set of systematic CBs; and processing the signal based on the first RV and the second RV.

Aspect 18 is the method of aspect 17, wherein the signal comprises a first set of coded bits and a second set of coded bits, wherein the first set of coded bits is based on a first rate matching for the first set of systematic CBs using the first RV and the second set of coded bits is based on a second rate matching for the second set of parity CBs using the second RV, wherein the first RV is different from the second RV.

Aspect 19 is the method of any of aspects 17 to 18, wherein processing the signal based on the first RV and the second RV comprises: decoding the signal based on the first RV and the second RV.

Aspect 20 is the method of aspect 19, wherein the method further includes decoding, in response to a decode failure on one systematic CB of the first set of systematic CBs, the one systematic CB based on the second set of parity CBs and remaining systematic CBs in the first set of systematic CBs.

Aspect 21 is the method of aspect 20, wherein decoding the one systematic CB based on the second set of parity CBs and the remaining systematic CBs in the first set of systematic CBs comprises: obtaining a first log-likelihood ratio (LLR) of the one systematic CB corresponding to the first RV and a second LLR of the one systematic CB corresponding to the second RV; and decoding the one systematic CB based on the first LLR and the second LLR.

Aspect 22 is the method of aspect 18, wherein a first length of coded bits for a systematic CB is different from a second length of coded bits for a parity CB.

Aspect 23 is the method of aspect 22, wherein the first length of the coded bits is longer than the second length of the coded bits.

Aspect 24 is the method of aspect 22, wherein the method further includes communicating, with the UE, the first length of the coded bits and the second length of the coded bits.

Aspect 25 is the method of any of aspects 18 to 24, wherein the second RV is based on an end point of the transmission of the first set of systematic CBs.

Aspect 26 is the method of aspect 25, wherein the second set of parity CBs is arranged in a circular buffer, and wherein the second set of coded bits includes a wraparound portion of the second set of parity CBs at a beginning of the circular buffer.

Aspect 27 is an apparatus for wireless communication at a network entity, comprising: at least one memory; and at least one processor coupled to the at least one memory and, where the at least one processor is configured to perform the method of any of aspects 17 to 26.

Aspect 28 is the apparatus for wireless communication at a network entity, comprising means for performing each step in the method of any of aspects 17 to 26.

Aspect 29 is an apparatus of any of aspects 27 to 28, further comprising a transceiver configured to receive or to transmit in association with the method of any of aspects 17 to 26.

Aspect 30 is a computer-readable medium (e.g., a non-transitory computer-readable medium) storing computer executable code at a network entity, the code when executed by at least one processor causes the at least one processor to perform the method of any of aspects 17 to 26.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
generate, based on a first set of systematic code blocks (CBs) associated with a transport block (TB), a second set of parity CBs for the first set of systematic CBs;
encode the first set of systematic CBs and the second set of parity CBs using a low-density parity-check (LDPC) code; and
communicate, with a network entity, the first set of systematic CBs and the second set of parity CBs using a first redundancy version (RV) and a second RV, respectively, wherein the first RV indicates a first starting point of a transmission of the first set of systematic CBs and the second RV indicates a second starting point of the transmission of the second set of parity CBs.

2. The apparatus of claim 1, further comprising a transceiver coupled to the at least one processor, wherein to communicate the first set of systematic CBs and the second set of parity CBs, the at least one processor is configured to communicate, via the transceiver, the first set of systematic CBs and the second set of parity CBs, wherein the at least one processor is further configured to:
perform a first rate matching for the first set of systematic CBs using the first RV to obtain a first set of coded bits; and
perform a second rate matching for the second set of parity CBs using the second RV to obtain a second set of coded bits, wherein the first RV is different from the second RV, and wherein to communicate, with the network entity, the first set of systematic CBs and the second set of parity CBs, the at least one processor is configured to:
communicate, with the network entity, the first set of coded bits and the second set of coded bits.

3. The apparatus of claim 2, wherein to generate the second set of parity CBs for the first set of systematic CBs, the at least one processor is configured to:
generate the second set of parity CBs using a bit-wise exclusive OR (XOR) operation between the systematic CBs of the first set of systematic CBs.

4. The apparatus of claim 2, wherein a first length of coded bits for a systematic CB is different from a second length of coded bits for a parity CB.

5. The apparatus of claim 4, wherein the first length of the coded bits is longer than the second length of the coded bits.

6. The apparatus of claim 4, wherein the at least one processor is further configured to:
communicate, with the network entity, the first length of the coded bits and the second length of the coded bits.

7. The apparatus of claim 6, wherein to communicate the first length of the coded bits and the second length of the coded bits, the at least one processor is configured to:
communicate the first length of the coded bits and the second length of the coded bits via one or more of:
downlink control information (DCI),
radio resource control (RRC) signaling, or
a medium access control (MAC)-control element (MAC-CE).

8. The apparatus of claim 2, wherein the at least one processor is further configured to:
partition the first set of systematic CBs into a third set of code block groups (CBGs), wherein each CBG in the third set of CBGs includes one or more systematic CBs of the first set of systematic CBs, and wherein to generate the second set of parity CBs for the first set of systematic CBs, the at least one processor is configured to:
generate the second set of parity CBs based on the third set of CBGs, wherein each parity CB of the second set of parity CBs corresponds to one CBG of the third set of CBGs.

9. The apparatus of claim 2, wherein the second RV is based on an end point of the transmission of the first set of systematic CBs.

10. The apparatus of claim 9, wherein the second set of parity CBs is arranged in a circular buffer, and wherein the second set of coded bits includes a wraparound portion of the second set of parity CBs at a beginning of the circular buffer.

11. The apparatus of claim 1, wherein to communicate, with the network entity, the first set of systematic CBs and the second set of parity CBs using the first RV and the second RV, respectively, the at least one processor is configured to:
transmit, to the network entity, a signal corresponding to the first set of systematic CBs and the second set of parity CBs using the first RV and the second RV, respectively.

12. The apparatus of claim 1, where the at least one processor is further configured to:
communicate, with the network entity, RV information comprising the first RV and the second RV via one or more of:
downlink control information (DCI),
radio resource control (RRC) signaling, or
a medium access control (MAC)-control element (MAC-CE).

13. An apparatus for wireless communication at a network entity, comprising:
at least one memory; and
at least one processor coupled to the at least one memory and, based at least in part on information stored in the at least one memory, the at least one processor is configured to:
receive, from a user equipment (UE), a signal corresponding to a first set of systematic code blocks (CBs) associated with a first redundancy version (RV) and a second set of parity CBs associated with a second RV, wherein the first RV indicates a first starting point of a transmission of the first set of systematic CBs and the second RV indicates a second starting point of the transmission of the second set of parity CBs, and wherein the first set of systematic CBs is associated with a transport block (TB) and the second set of parity CBs is based on the first set of systematic CBs; and
process the signal based on the first RV and the second RV.

14. The apparatus of claim 13, further comprising a transceiver coupled to the at least one processor, wherein to receive the signal, the at least one processor is configured to receive the signal via the transceiver, and wherein the signal comprises a first set of coded bits and a second set of coded bits, wherein the first set of coded bits is based on a first rate matching for the first set of systematic CBs using the first RV and the second set of coded bits is based on a second rate matching for the second set of parity CBs using the second RV, wherein the first RV is different from the second RV.

15. The apparatus of claim 14, wherein to process the signal based on the first RV and the second RV, the at least one processor is configured to:
decode the signal based on the first RV and the second RV.

16. The apparatus of claim 15, wherein the at least one processor is further configured to:
decode, in response to a decode failure on one systematic CB of the first set of systematic CBs, the one systematic CB based on the second set of parity CBs and remaining systematic CBs in the first set of systematic CBs.

17. The apparatus of claim 16, wherein to decode the one systematic CB based on the second set of parity CBs and the remaining systematic CBs in the first set of systematic CBs, the at least one processor is configured to:
obtain a first log-likelihood ratio (LLR) of the one systematic CB corresponding to the first RV and a second LLR of the one systematic CB corresponding to the second RV; and
decode the one systematic CB based on the first LLR and the second LLR.

18. The apparatus of claim 14, wherein a first length of coded bits for a systematic CB is different from a second length of coded bits for a parity CB.

19. The apparatus of claim 18, wherein the first length of the coded bits is longer than the second length of the coded bits.

20. A method of wireless communication at a user equipment (UE), comprising:
generating, based on a first set of systematic code blocks (CBs) associated with a transport block (TB), a second set of parity CBs for the first set of systematic CBs;
encoding the first set of systematic CBs and the second set of parity CBs using a low-density parity-check (LDPC) code; and
communicating, with a network entity, the first set of systematic CBs and the second set of parity CBs using a first redundancy version (RV) and a second RV, respectively, wherein the first RV indicates a first starting point of a transmission of the first set of systematic CBs and the second RV indicates a second starting point of the transmission of the second set of parity CBs.
